(19) United States
(12) Patent Application Publication
(10) Pub. No.: US 2004/0125234 A1
(43) Pub. Date: Jul. 1, 2004

(54) Lighting apparatus of television

(76) Inventor: Mi-Sun Kim, Inchon City (KR)

Correspondence Address: William H. Logsdon, WEBB ZIESENHEIM LOGSDON ORKIN & HANSON, P.C., 700 Koppers Building, 436 Seventh Avenue, Pittsburgh, PA, 15219-1818, US

(21) Appl. No.: 10/628,889

(22) Filed: Jul. 28, 2003

(30) Foreign Application Priority Data
Jul. 29, 2002 (KR) 2002-22631

(51) Int. Cl. H04N 7/00

(52) U.S. Cl. 348/552; 348/553

(57) ABSTRACT

The present invention relates generally to a lighting apparatus of a television, and more particularly to a lighting apparatus of a television, in which fluorescent lamps or various types of lamps are installed in both side portions or upper and lower portions of the television close to a screen thereof while the television is turned off, thus obtaining an indirect lighting effect. The lighting apparatus of the present invention includes one or more lamps (20) installed to be concealed close to the screen of the television, a ballast (22) to stably supply power to the lamps (20), a power supply unit (24) to supply power necessary for both the ballast (22) and the entire lighting apparatus, an ON/OFF switch unit (26) to turn on/off the lamps (20), a control unit (28) to provide with programs for controlling the lighting apparatus and used to operate the ON/OFF switch unit (26), a television state detecting unit (30) to detect ON/OFF operating states of the television, a remote control sensor unit (32) to receive operating commands for turning on/off the lamps (20), an illuminance detecting unit (34) outputs an electrical signal corresponding to the variation of external illuminance, and a communication interface unit (36) to receive signals to turn on/off the lighting apparatus from outside a home.

### BACKGROUND OF THE INVENTION

1. Field of the Invention

The present invention relates generally to a lighting apparatus of a television, and more particularly to a lighting apparatus of a television, in which fluorescent lamps or various types of lamps are installed in both side portions or upper and lower portions of the television close to a screen thereof while the television is turned off, thus obtaining an indirect lighting effect.

2. Description of the Related Art

Most homes are equipped with one or more televisions. Such televisions have developed from a conventional analog type to a digital type. Recently, even a television having a satellite broadcast reception function has appeared.

In spite of functional improvements to televisions, they do not provide any special function except for transmission of information, such as news or debates on current topics, and entertainment, such as popular song programs or television drama programs. For example, a lighting apparatus is still installed separately from a television, and is used in the form of a main lighting apparatus and a subsidiary indirect lighting apparatus for providing a night light function. Especially, the indirect lighting apparatus used at night requires high installation costs thereof like in the case of the main lighting apparatus. However, the indirect lighting apparatus is not actually frequently used, thus wasting the cost thereof.

Therefore, there is required a television product capable of easily providing an indirect lighting function requiring high costs in the prior art, and improving the function and service of the television product by providing additional functions to the television.

### SUMMARY OF THE INVENTION

Accordingly, the present invention has been made keeping in mind the above problems occurring in the prior art, and an object of the present invention is to provide a lighting apparatus of a television, in which fluorescent lamps or various types of lamps are installed in both side portions or upper and lower portions of the television close to a screen thereof while the television is turned off, thus obtaining an indirect lighting effect.

Another object of the present invention is to provide a lighting apparatus of a television, which can create added value for a television by improving a function thereof, and provide the improved function thereof.

A further object of the present invention is to provide a lighting apparatus of a television, which is operated according to external illumination or ON/OFF commands issued from a remote place, and is automatically turned off when the television is turned on.

In order to accomplish the above object, the present invention provides a lighting apparatus of a television, comprising one or more lamps installed to be concealed close to the screen of the television, a ballast for stably supplying power to the lamps, a power supply unit for supplying power necessary for both the ballast and the entire lighting apparatus, an ON/OFF switch unit for turning on/off the lamps, a control unit provided with programs for controlling the lighting apparatus and used to operate the ON/OFF switch unit, a television state detecting unit for detecting ON/OFF operating states of the television, and a remote control sensor unit for receiving operating commands for turning on/off the lamps.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a front view of a television equipped with a lighting apparatus according to the present invention;

FIG. 2 is a side sectional view taken along line A-A of FIG. 1;

FIG. 3 is a block diagram of the lighting apparatus according to the present invention; and

FIG. 4 is a flowchart of the operation of the lighting apparatus according to the present invention.

### DESCRIPTION OF THE PREFERRED EMBODIMENTS

Hereinafter, embodiments of the present invention will be described in detail with reference to the attached drawings.

The present invention relates to a lighting apparatus installed in a television, which is especially advantageous in that, since it functions as an indirect lighting apparatus, the necessity of installing an expensive indirect lighting apparatus used in the prior art can be reduced, and an improved service and function can be provided to users.

FIG. 1 is a front view of a television according to the present invention.

As shown in FIG. 1, the television includes a typical screen 16, a remote control sensor 12 and a tuning control panel 14. In this case, light is irradiated from both sides of the screen 16. That is, light is irradiated from a pair of lamps 20 installed close to the screen 16. In FIG. 1, the lamps 20 are shown in dotted lines. Actually, the lamps 20 are concealed to prevent a user from visually recognizing the lamps 20. The lamps 20 can be installed in one side portion of the television 16, instead of in both the side portions thereof, as shown in FIG. 1. Further, the lamps 20 can be selectively installed in an upper or lower portion of the television, instead of in both the side portions thereof.

Further, capillary lamps can be used as the lamps 20 in the lighting apparatus. In addition, lamps with usable colors for indirect lighting, such as a plurality of incandescent lamps, lamps with surfaces applied with colors, or neon lamps, as well as fluorescent lamps, can be used as the lamps 20. It is clear that these lamps are of types which can also be used for a main lighting apparatus.

According to the types of lamps used in the lighting apparatus, devices necessary for the supply of power can vary. For example, in the case of capillary lamps using commercial Alternating Current (AC) power, power is supplied using a ballast or an inverter. Further, in the case of lamps using Direct Current (DC) power, a rectifier for rectifying AC power to DC power can be provided. Therefore, it is clear that the variations of a power supply unit according to the types of lamps belong to the scope of the present invention.

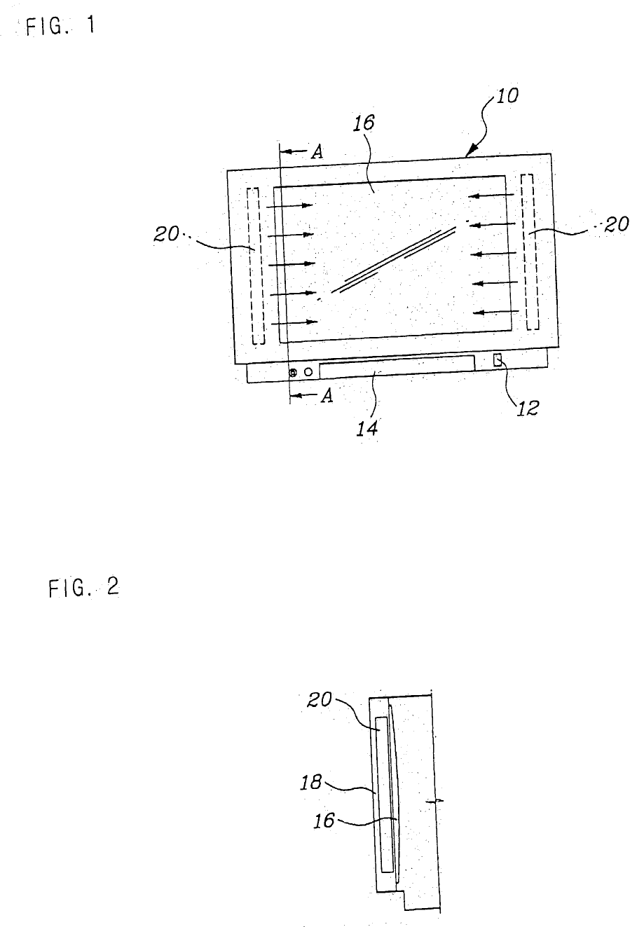

FIG. 2 is a side sectional view taken along line A-A of FIG. 1.

As shown in FIG. 2, the lamps 20 are each installed to be projected relative to the surface of the screen 16 (that is, a screen on which an image is displayed). Further, it is difficult to recognize each lamp 20 from in front of the television or from a position beside the television due to each projection part 18 formed on the television. The projection part 18 is formed to be integrated into a casing of the television. A space formed by the projection part 18 is adjusted in its width to cause light to be sufficiently radiated from each of the lamps 20 to the outside. Further, the width of the space from which light escapes is adjusted according to the size of different types of lamps, such as incandescent lamps or neon lamps.

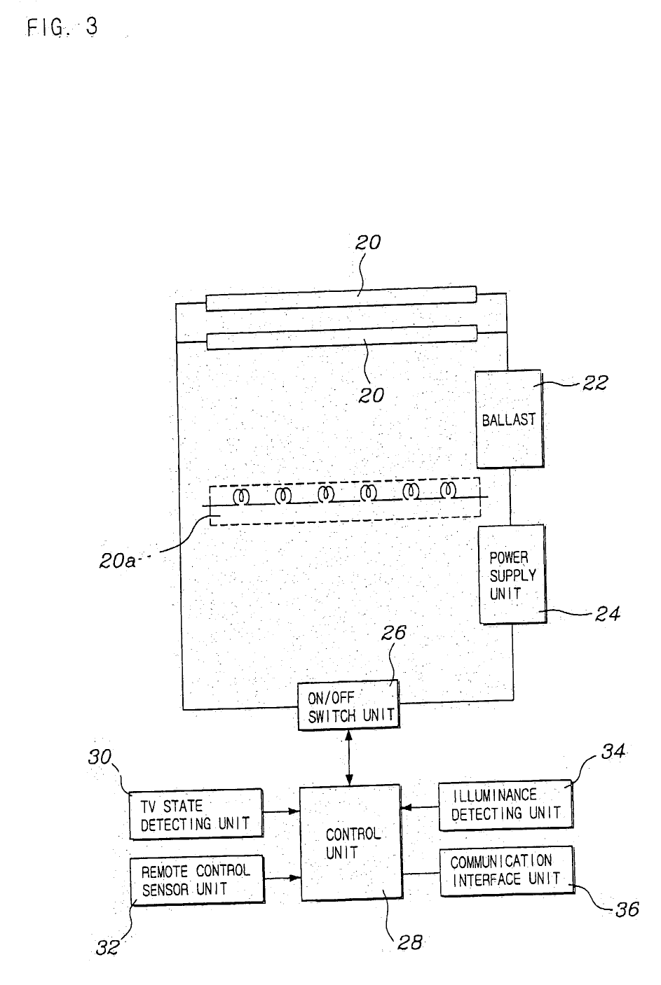

A block diagram of the lighting apparatus for supplying power to the lamps 20 having the above construction and controlling ON/OFF operating states thereof is depicted in FIG. 3.

As shown in FIG. 3, the lighting apparatus includes one or more lamps 20 installed to be concealed close to the screen of the television, a ballast 22 for stably supplying power to the lamps 20, a power supply unit 24 for supplying power necessary for both the ballast 22 and the entire lighting apparatus, an ON/OFF switch unit 26 for turning on/off the lamps 20, a control unit 28 provided with programs for controlling the lighting apparatus and used to operate the ON/OFF switch unit 26, a television state detecting unit 30 for detecting ON/OFF operating states of the television, a remote control sensor unit 32 for receiving ON/OFF operating commands for turning on/off the lamps 20, an illuminance detecting unit 34 for outputting an electrical signal corresponding to the variation of external illuminance, and a communication interface unit 36 for receiving signals to turn on/off the lighting apparatus from outside a home.

The ballast 22 is used to stably supply power (AC power) to the lamps 20. Power supplied to the ballast 22 is provided from the power supply unit 24. The power supply unit 24 receives an operating voltage using power supplied to the television and supplies the operating voltage to the ballast 22. Alternatively, the power supply unit 24 can be supplied with power separately from the power of the television using an additional power supply means (for example, an additional plug). The ON/OFF switch unit 26 is disposed between the power supply unit 24 and the lamps 20 to turn on/off the lamps 20.

The ON/OFF switch unit 26 can be operated using a switching circuit or a relay for performing ON/OFF operations.

The control unit 28 controls the ON/OFF switch unit 26 to perform the ON/OFF operations. The control unit 28 can be implemented using a microprocessor. The control unit 28 turns on/off the lamps 20 in response to an ON/OFF control signal input from the outside of the television. At this time, in order to prevent the indirect lighting from operating while the television is turned on, the ON/OFF operating states of the television are first detected using the television state detecting unit 30. As a detected result, if the television is in a turned-on state, a command for turning on the indirect lighting is ignored, while if the television is in a turned-off state, the command for turning on the indirect lighting is executed to turn on the lamps 20. If the lamps 20 are turned on, indirect light is radiated in the direction of the arrows in FIG. 1.

The remote control sensor unit 32 applies ON/OFF operating commands to the control unit 28. The remote control sensor unit 32 receives ON/OFF command signals for the lamps 20, received through a remote controller (not shown), and transmits the ON/OFF command signals to the control unit 28. It is clear that the remote control sensor unit 32 can be constructed using a remote control sensor unit of the television, or separately constructed as an additional remote control sensor unit. The remote controller can be constructed so that ON/OFF commands for the lighting apparatus are input to a remote controller for controlling the television.

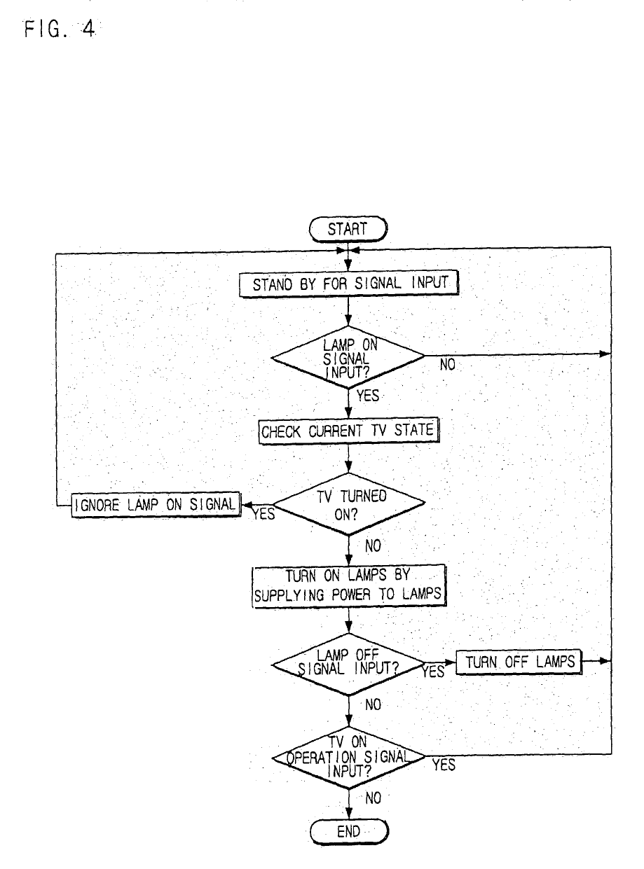

The operating states of the lighting apparatus of the television according to the present invention having the above construction are described in detail with reference to the flowchart of FIG. 4.

If power is supplied to both the television and the lighting apparatus, they stand by. For convenience of description, it is assumed that the lighting apparatus is initially in a turned-off state. If a command signal for turning on the lamps 20 has been input through the remote controller, the control unit 28 detects a current operating state of the television. If the television is in a turned-on state according to the detected result, the control unit 28 ignores the input command signal, and continues to stand by for a command signal.

If the television is in a turned-off state according to the detected result, the control unit 28 outputs a command signal for supplying power to the lamps 20. The command signal output from the control unit 28 is input to the ON/OFF switch unit 26. The ON/OFF switch unit 26 is turned on in response to the command signal to supply power to the lamps 20. Therefore, the lamps 20 are supplied with power to radiate indirect light.

In such a power-on state, if a lamp OFF signal has been input, the control unit 28 outputs an OFF command to the ON/OFF switch unit 26 so as to turn off the lamps 20. Therefore, the lamps 20 are turned off.

Meanwhile, the control unit 28 continuously detects the operating state of the television through the television state detecting unit 30. In this case, if an ON operation signal for the television has been input by the user to operate the television, the control unit 28 detects this operating state of the television to output a command for turning off the lamps 20. Therefore, while the television is turned on, the lighting apparatus of the present invention stops the operation thereof.

The present invention may further include the illuminance detecting unit 34 for detecting external illuminance, thereby performing an automatic operation of the lighting apparatus. The illuminance detecting unit 34 can be implemented so that it detects external illuminance using a sensor (not shown) connected thereto, and automatically turns on or off the indirect lighting if the illuminance reaches a preset threshold value. Therefore, if the illuminance detecting unit 34 is provided, a lighting operation can be performed by automatically operating the lamps 20 at night for providing indirect lighting without user's operating the lamps 20 using the remote controller. This operation can provide a useful function when a user comes home at night after going out. The illuminance detecting unit 34 can be implemented in such a way that a sensor for detecting illuminance is installed close to the front tuning control panel or the remote control sensor 12 of the television.

Further, in the present invention, the lighting apparatus of the television can be controlled from a remote place using the communication interface unit 36. The communication interface unit 36 is provided with a function capable of transmitting/receiving data from/to the Internet or a telephone line, and related hardware. Therefore, the user can operate the lamps 20 by connecting the lighting apparatus of the television to the Internet or a telephone.

This remote control operation provides a function of allowing parents of a young child to turn on the lamps 20 from a remote place for the young child within a home incapable of operating the lamps 20. In this case, it is preferable to change the lamps 20 so that the lamps 20 can be used for direct lighting instead of indirect lighting.

ON/OFF control signals for the lamps 20, input through the illuminance detecting unit 34 or the communication interface unit 36 further included in the present invention, are also equally influenced by the ON/OFF states of the television. That is, similar to the ON/OFF commands input through the remote control sensor unit 32, the ON/OFF control signals are ignored while the television is turned on.

As described above, the present invention provides a lighting apparatus of a television, in which fluorescent lamps or various types of lamps are installed in both side portions of the television close to a screen thereof while the television is turned off, thus obtaining an indirect lighting effect.

Further, the present invention is advantageous in that the lighting apparatus can be controlled by utilizing a remote controller of a television, or by accessing the television from a remote place through an illuminance detector or communication interface.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A lighting apparatus of a television, comprising:
one or more lamps installed to be concealed close to the screen of the television;
a ballast for stably supplying power to the lamps;
a power supply unit for supplying power necessary for both the ballast and the entire lighting apparatus;
an ON/OFF switch unit for turning on/off the lamps;
a control unit provided with programs for controlling the lighting apparatus and used to operate the ON/OFF switch unit;
a television state detecting unit for detecting ON/OFF operating states of the television; and
a remote control sensor unit for receiving ON/OFF operating commands for turning on/off the lamps.

2. The lighting apparatus according to claim 1, further comprising a bright detecting unit for detecting variation of external illuminance using a sensor, and outputting an electrical signal corresponding to the variation thereof.

3. The lighting apparatus according to claim 1, further comprising a communication interface unit for receiving signals to turn on/off the lighting apparatus from outside a home, and performing a data communication function through the Internet or a data communication function through a telephone line.
